(19) United States
(12) Patent Application Publication
(10) Pub. No.: US 2014/0281375 A1
(43) Pub. Date: Sep. 18, 2014

(54) RUN-TIME INSTRUMENTATION HANDLING IN A SUPERSCALAR PROCESSOR

(71) Applicant: INTERNATIONAL BUSINESS MACHINES CORPORATION, Armonk, NY (US)

(72) Inventors: Gregory W. Alexander, Pflugerville, TX (US); Mark S. Farrell, Pleasant Valley, NY (US); Wolfgang Fischer, Hildrizhausen (DE); Guenter Gerwig, Simmozheim (DE); Frank Lehnert, Schoenbuch (DE); Chung-Lung Shum, Wappingers Fall, NY (US)

(73) Assignee: International Business Machines Corporation, Armonk, NY (US)

(21) Appl. No.: 13/843,375

(22) Filed: Mar. 15, 2013

(51) Int. Cl. G06F 9/38

(52) U.S. Cl. CPC G06F 9/3851
USPC 712/23

(57) ABSTRACT

A method and a computer program for a processor simultaneously handle multiple instructions at a time. The method includes labeling of an instruction ending a relevant sample interval from a plurality of such instructions. Further, the method utilizes a buffer to store N more number of entries than actually required, wherein, N refers to the number of RI instructions younger than the instruction ending a sample interval. Further, the method also includes the step of recording relevant instrumentation data corresponding to the sample interval and providing the instrumentation data in response to identification of the sample interval.

### FIELD OF INVENTION

This invention generally relates to performance monitoring of processors. More specifically, the invention relates to recording instrumentation data to monitor performance of a superscalar processor.

### BACKGROUND

Several current processor designs incorporate superscalar architectures. Such architectures simultaneously handle multiple instruction groups of one or more programs that are distributed to multiple pipeline processing stages of the processor. Such architectures are also able to distribute instructions to the various processing stages in orders other than that specified by the program, subject to instruction dependencies.

Processing instrumentation is incorporated into the processors to support analysis of executing programs by, for example, facilitating identification of processing performance bottlenecks for the computer program being analyzed. Processor performance measurement enables detection of issues that can result in reduced throughput of the processor. One approach to measuring performance is to repeatedly execute workload instruction streams, which are often segments of customer workload code that stress particular hardware and/or software functions, and collect data relevant to the system's performance. Initially, hardware captures selected signals and stores them for further analysis. Each group of the selected signals is called a “sample” that is associated with executing an instruction. Each sample can contain various information about processor state for performance evaluation, such as process ID, virtual storage address, op-code and information about activity associated with the instruction (delays, caching, etc.). The captured data are later used for calculating performance analysis.

Typically, there are many instructions executing at a given time in a superscalar processor. In assessing processing clogs, the best indication of which stalls are delaying the processor, versus ones that may be hidden by other instructions, is to look at the Next-To-Complete (NTC) instruction or group of instructions. Given that instrumentation data samples are taken at random times to not skew the observed results, it is difficult to collect information about the NTC group of instructions without collecting information on all instructions active in the pipeline. There are typically many instructions being simultaneously handled by the processor and active in the processing pipeline of a superscalar processor and there are many stages of the processing pipeline that require monitoring for instruction stall conditions. Staging the stall conditions through the pipeline often adds complexity as the size of the pipeline and the number of simultaneously active instruction groups increases. Such staging for all required processing pipeline stages and for all active instructions requires a large amount of latches to implement.

In light of the above discussion, there is a need for a more efficient processing instrumentation architecture for a superscalar processor. Also required in a more efficient processing instrumentation system that may improve the processing performance monitoring of such processors.

### BRIEF SUMMARY

In one embodiment of the disclosure, a method for recording of instrumentation data is provided, which includes labeling of one of an instruction as a relevant instruction ending a sample interval, out of a plurality of instructions which are being simultaneously processed by the processor. The method further includes, recording of instrumentation data, in acknowledgement of labeling, which corresponds to the relevant sample interval. The instrumentation data for the sample interval is stored in a single buffer only. Further, the method includes, acquiring of a sample interval and deciding, in acknowledgement to acquiring, whether the relevant instruction is flagged as a next-to-complete instruction. The method also includes, writing of the corresponding instrumentation data, the corresponding instrumentation data as instrumentation data output.

In another embodiment of the disclosure, a system for recording of instrumentation data includes a processor that has a plurality of pipelined instruction execution stages. The system further includes a labeling module which is configured to label one of the instruction from a plurality of instructions as a relevant instruction ending a sample interval. The system also includes a circuit which is configured to record corresponding instrumentation data in acknowledgement to labeling of the relevant instruction. Here, only a single buffer stores the corresponding instrumentation data for the plurality of instructions. The system further includes a sample interval input which is configured to acquire a sample interval. A decision module is included in the system, to decide, in acknowledgement to acquiring of the sample interval, that the relevant instruction is flagged as next-to-complete instruction. The system also includes an output module which is configured to write, the corresponding instrumentation data in response to determining the relevant instruction being marked as next-to-complete instruction, and provides the corresponding instrumentation data as instrumentation data output.

In another embodiment, a computer part program for collecting instrumentation data for a processor includes a computer readable storage medium having a computer readable program code embodied therewith which includes a computer program code configured to label one of the instructions from a plurality of instructions as a relevant instruction. The plural instructions are simultaneously processed by the processor. The computer readable program code is also configured to record, in acknowledgement to the labeling, a corresponding instrumentation to the relevant instruction only. Here only a single buffer is configured to store all the instrumentation data corresponding to the plurality of instructions. The computer readable program code is further configured to acquire a sample interval and includes configuration to decide, in acknowledgement of acquiring the sample interval, that the relevant instruction is flagged as next-to-complete instruction. The computer program code is also configured to write, in acknowledgement to determine the relevant instruction as a next-to-complete group, the corresponding instrumentation data. The computer program code is further configured to provide the corresponding data, in acknowledgement to acquiring the sample signal and recording of the corresponding instrumentation data, as an instrumentation data output.

### BRIEF DESCRIPTION OF DRAWINGS

The features of the present invention, which are believed to be novel, are set forth with particularity in the appended claims. The invention may best be understood by reference to the following description, taken in conjunction with the accompanying drawings. These drawings and the associated description are provided to illustrate some embodiments of the disclosure, and not to limit the scope of the disclosure.

FIG. 1 is a block diagram illustrating collection of instrumentation data output; and

FIG. 2 is a block diagram illustrating process flow after a sample interval is acquired.

Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present invention.

There may be additional structures described in the foregoing application that are not depicted on one of the described drawings. In the event such a structure is described, but not depicted in a drawing, the absence of such a drawing should not be considered as an omission of such design from the specification.

### DETAILED DESCRIPTION

Before describing the present invention in detail, it should be observed that the present invention utilizes a combination of method steps and apparatus components related to a rework device for repairing printed circuit assemblies. Accordingly the apparatus components and the method steps have been represented where appropriate by conventional symbols in the drawings, showing only specific details that are pertinent for an understanding of the present invention so as not to obscure the disclosure with details that will be readily apparent to those with ordinary skill in the art having the benefit of the description herein.

While the specification concludes with the claims defining the features of the disclosure that are regarded as novel, it is believed that the invention will be better understood from a consideration of the following description in conjunction with the drawings, in which like reference numerals are carried forward.

As required, detailed embodiments of the present invention are disclosed herein; however, it is to be understood that the disclosed embodiments are merely exemplary of the disclosure, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the disclosure.

The terms “a” or “an”, as used herein, are defined as one or more than one. The term “another”, as used herein, is defined as at least a second or more. The terms “including” and/or “having” as used herein, are defined as comprising (i.e. open transition). The term “coupled” or “operatively coupled” as used herein, is defined as connected, although not necessarily directly, and not necessarily mechanically.

The present invention, according to preferred embodiments, provides a system or method for collection of instrumentation data of a processor which can process a plurality of instructions in a single clock cycle.

FIG. 1 illustrates a process flow 100 for recording of instrumentation data, as according to one embodiment of the present invention. The processing starts at 102. Thereafter, at step 104, one instruction from a plurality of instructions, is labeled as a relevant instruction ending a sample interval. In an embodiment according to the present invention, there are three ways to end the sample interval. The sample interval can be ended firstly through a time based manner, wherein the sample interval automatically ends after a certain time frame. Secondly, the sample interval can be ended after execution of a specific number of instructions. Thirdly, the sample interval can be ended by performing a direct sampling of the sample interval. The plural instructions are simultaneously processed by the processor. At step 106, the processing further involves recording of corresponding instrumentation data for the relevant sample interval. All the instrumentation data corresponding to the plurality of instructions are stored in multiple registers belonging to a single buffer. Storage of instrumentation in a single buffer gives an advantage as multiple data buffers are not required to store instrumentation data belonging to different sample interval. Also, the buffer contains N additional entries than originally required, where N is the number of RI relevant instructions which are younger than the instruction ending the sample interval. The buffer is capable of storing any number of entries per sample interval.

Another advantage of the invention is that buffer update is performed at completion time. Therefore, there is no need of deletion of entries in case an instruction is invalidated.

As mentioned above, the buffer contains a number of RI instructions. RI instructions are instructions which are utilized for delivering instrumentation data.

At step 108, there is the step of acquiring sample interval if the label instruction is complete, as described above. The processing proceeds at step 112, with the instrumentation data being written in response to determining of the sample interval instruction as the next-to-complete instruction.

The processing flow further renders, at step 114, the corresponding instrumentation data to the instruction labeled as the relevant instruction.

Referring to FIG. 2, a block diagram shows a detailed process flow of steps performed after acquiring a sample interval. The process 200 is initiated at step 202 after the step 108, wherein a sample interval is acquired if the label instruction is complete. After this step has been performed, the processing continues to step 204, where the buffer storing the instrumentation data for the plurality of instructions is frozen. The buffer is frozen in acknowledgement of determination and acquiring of the sample interval. Further, at step 206, a software module is invoked, which is in acknowledgement to the freezing of the buffer. One of the examples of that may be used include, but are not limited to a millicode.

The corresponding instrumentation data, to the relevant instruction which has been identified as the sample interval, is extracted from the buffer at step 208.

The process continues at step 210, wherein the software module invoked at step 206, moves remaining instrumentation data in the registers of the buffer, from which the instrumentation data has been fetched. Therefore, the remaining instrumentation data takes place of the corresponding instrumentation data fetched by the sample interval.

The process also includes the generation of a wrap flag that is triggered by a pre-selected threshold being reached, such as the number of entries being written. One embodiment of the invention uses 30 entries as this pre-selected threshold to trigger generation of the wrap flag. If the wrap flag appears, there are the following two possibilities: (i) overwriting is occurring because the threshold has been exceeded with more than 30 entries being written; or (ii) there are entries left from an old sample interval, and in this way, the wrap flag functions to weed out entries belonging to an old interval. By doing (ii), the process of the invention ensures that it is measuring entries corresponding to a sample interval

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

### NON-LIMITING EXAMPLES

Although specific embodiments of the disclosure have been disclosed, those having ordinary skill in the art will understand that changes can be made to the specific embodiments without departing from the spirit and scope of the disclosure. The scope of the disclosure is not to be restricted, therefore, to the specific embodiments, and it is intended that the appended claims cover any and all such applications, modifications, and embodiments within the scope of the present invention.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

We claim:

1. A method for recording instrumentation data for a processor configured to simultaneously process a plurality of instructions, the method comprising:
labeling of an instruction from a plurality of instructions, as a relevant instruction ending a sample interval, wherein the plurality of instructions are simultaneously processed by the processor, the processor having a plurality of pipelined instruction execution stages;
recording corresponding instrumentation data for the relevant sample interval, wherein a single buffer stores corresponding instrumentation data for the relevant sample interval;
acquiring a sample interval;
deciding upon acquiring the sample interval that a relevant RI instruction completing together with the instruction ending a sample interval belongs to the current or to the next sample interval;
writing the corresponding instrumentation data; and
providing the corresponding instrumentation data as an instrumentation data output.

2. The method according to claim 1, wherein the buffer stores N additional entries than actually required.

3. The method according to claim 2, wherein N is number of the RI instructions within a group which are younger than the instruction within that group that ends a sample interval.

4. The method according to claim 1, further comprising, freezing the buffer up on acquiring the sample interval.

5. The method according to claim 1, further comprising providing the corresponding instrumentation data to the sample interval.

6. The method according the claim 3, further comprising, replacing registers present in the buffer with remaining corresponding instrumentation data belonging to the next sample interval

7. The method according to claim 1, further comprising unfreezing the buffer.

8. A system for recording instrumentation data for a processor configured to simultaneously process a plurality of instructions, the system comprising:
the processor having a plurality of pipelined instruction execution stages;
a labeling module configured to label an instruction from a plurality of instructions, as a relevant instruction ending a sample interval, wherein the plurality of instructions are simultaneously processed by the processor;
a circuit configured to record corresponding instrumentation data for the RI relevant instruction, wherein a single buffer stores corresponding instrumentation data for the plurality of RI relevant instructions;
a sample interval input module to acquire a trigger condition if an instruction group has been completed which contains the labeled instruction ending a sample interval;
a decision module to decide whether the RI relevant instruction completing together with the sample instruction ending an interval belongs to the current or to a next sample interval and
an output module, wherein the output module is configured to provide the corresponding instrumentation data as an instrumentation data output.

9. The method of claim 8, wherein the buffer stores N additional entries than actually required.

10. The method of claim 8, wherein N is the number of the RI instructions within a group that is completing which are younger than the instruction within that group that ends a sample interval.

11. The system of claim 8, wherein the buffer is frozen on acquiring the sample interval.

12. The system of claim 8, further comprising a software module, the software module being configured to provide the corresponding instrumentation data to the sample interval.

13. The system of claim 12, wherein the software module is further configured to replace registers present in the buffer with remaining corresponding instrumentation data belonging to the next sample interval.

14. The system of claim 12, wherein the software module is further configured to unfreeze the buffer.

15. The system of claim 12, wherein the next sample interval contains an extra sample

16. The system of claim of 15, wherein the system further comprises a wrap flag that is set if the extra sample is written into the buffer.

17. A computer program product comprising computer readable medium, the computer readable medium comprising a program code used by a processor for execution on a computing system, with a purpose of collecting processor instrumentation data for a processor configured to simultaneously process a plurality of instructions, the computer program product comprising instructions for:
labeling of an instruction from a plurality of instruction, as a relevant instruction ending a sample interval, wherein the plurality of instructions are simultaneously processed by the processor, the processor having a plurality of pipelined instruction execution stages;
recording corresponding instrumentation data for the relevant RI instruction, wherein a single buffer stores corresponding instrumentation data for the plurality of RI instructions
acquiring a sample interval;
deciding upon acquiring the sample interval that a relevant RI instruction completing together with the instruction ending a sample interval; belongs to the current or to a next sample interval; and
providing the corresponding instrumentation data as an instrumentation data output.

18. The computer program product of claim 17, wherein the buffer stores N additional entries than actually required.

19. The computer part program product of claim 17, wherein N is the number of the RI instructions within a group which are younger than the instruction in that group that ends the sample interval

20. The computer program product of claim 17, further comprising instructions for freezing the buffer up on acquiring the sample interval.

21. The computer program product of claim 17, further comprising instructions for rendering the corresponding instrumentation data to the sample interval.

22. The computer program product of claim 21, further comprising instructions for replacing registers present in the buffer with remaining corresponding instrumentation data

23. The computer program product of claim 17, comprising instructions for unfreezing the buffer.

24. The system of claim 17, wherein the next sample interval contains an extra sample

25. The system of claim of 24, wherein the system further comprises of a wrap flag that is set if the extra sample is written into the buffer.
